(19) United States
(12) Patent Application Publication
(10) Pub. No.: US 2024/0180230 A1
(43) Pub. Date: Jun. 6, 2024

(54) APPARATUS AND METHOD FOR ALIGNING ROD-SHAPED ARTICLES

(71) Applicant: Philip Morris Products S.A., Neuchatel (CH)

(72) Inventors: Luca BOSI, Modigliana (IT); Filippo BATTISTI, Modena (IT)

(73) Assignee: Philip Morris Products S.A., Neuchatel (CH)

(21) Appl. No.: 18/551,917

(22) PCT Filed: Mar. 28, 2022
(86) PCT No.: PCT/EP2022/058077

§ 371 Date: Sep. 22, 2023

(30) Foreign Application Priority Data
Mar. 29, 2021 (EP) 21165561.8

(51) Int. Cl. A24C 5/32; A24C 5/01; A24C 5/34

(52) U.S. Cl. CPC A24C 5/327; A24C 5/01; A24C 5/3412

(57) ABSTRACT

An apparatus for aligning rod-shaped articles including a reference element is provided, the apparatus including: a conveyor configured to accommodate and to transport a rod-shaped article including a reference element; a holder configured to hold the article in the conveyor, the holder allowing temporary rotation of the article; a detection device configured to detect a rotational position of the article by detecting a position of the reference element; a mechanical positioner configured to rotate the article held by the holder around a longitudinal axis of the article; and a controller configured to submit information on the rotational position of the reference element of the article provided by the detection device to an actuator of the mechanical positioner, the actuator being configured to activate the mechanical positioner such that the article is rotated around the longitudinal axis from a detected position to a defined position by the mechanical positioner.

The present disclosure relates to an apparatus and method for aligning rod-shaped articles comprising reference element.

In electronic heated-not-burn devices using induction heating, the rod-shaped consumables comprise a susceptor band that is inductively heated by alternating magnetic fields for heating aerosol-forming substrate in proximity of the susceptor band. Upon manufacturing the consumables, a continuous susceptor band is inserted into aerosol-forming substrate. A continuous rod is formed and then cut into individual segments, which segments are combined with other segments to form the consumable to be used with the induction heating device.

In the rod, the susceptor band should be allocated in the center. The susceptor band should not be damaged or deformed by the cutting process. Both location and integrity of the susceptor may alter the heating efficiency, temperature distribution or may lead to inconsistency of the performance of the consumables.

For cutting the rods, the rods may be placed in flutes of a conveyor drum and cut by a circular knife. However, because the rods typically come to the conveyor drum from a mass flow, for example in a hopper, the position of a rod on the conveyor drum is random, so that the rotational position of the susceptor band inside the rod in relation to the axis of the conveyor drum is random. Consequently, the cutting angle under which the susceptor band is cut by the circular knife is random.

From the European patent publication EP 3461352 it is known to rotate articles of the tobacco processing industries such that the magnetic bands in the articles all have a same vertical or horizontal position with respect to their flutes. The magnetic bands are rotated by means of a magnetizing device interacting with the magnetic band in the articles. Since mechanical means are known to be very reliable, it would be desirable to provide an apparatus and method for aligning rod-shaped articles using mechanical means. It would be desirable to have such an apparatus and method, wherein a rotational position of the article, preferably before cutting, is defined for all articles and preferably optimized for cutting the articles.

There is provided an apparatus for aligning rod-shaped aerosol-generating articles comprising a reference element. The apparatus comprises a conveyor for accommodating and transporting a rod-shaped article comprising a reference element. The apparatus comprises a holding means for holding the rod-shaped article in the conveyor, wherein the holding means allows temporary rotation of the rod-shaped article. The apparatus further comprises a detection device for detecting the rotational position of the rod-shaped article by detecting the position of the reference element, a mechanical positioning unit to rotate the rod-shaped article held by the holding means around a longitudinal axis of the article, and a controller for submitting information on the rotational position of the reference element of the rod-shaped article provided by the detection device to an actuator of the mechanical positioning unit. Therein, the actuator is adapted to activate the mechanical positioning unit such that the rod-shaped article is rotated around a longitudinal axis of the article from a detected position to a defined position by the mechanical positioning unit.

Mechanical means to rotate an article, in particular a rod-shaped article of the tobacco or smoking industries, are known to be reliable, fast, well controllable and finely tuneable. In addition, mechanical means specifically act on the intended object only, as compared to for example magnetic fields of a magnetizing device that tends to interact with all magnetic or magnetisable material in the vicinity of the device.

There are several applications, where a fixed spatial orientation of an article coming out of a mass flow is required. For example, a print to be applied to a defined part of the article, a cutting of the article at a specific angle, or detection of a localized part of the article.

In order to be able to detect a rotational position of such a rod-shaped article, the article comprises a reference element. The reference element is not rotationally symmetric with respect to a longitudinal rotation axis of the article. It may, however, be symmetric with respect to a longitudinal middle plane of the article (180 degree symmetry). This rotational asymmetry allows to detect and define a rotational orientation of the article by detecting the position of the reference element of the article. The reference element may be inside the article or on the outside of the article, such as for example a component in the article or an external marking on the article.

The rod-shaped article may, for example, be a rod-shaped aerosol-generating article, a rod-shaped filter element or any rod-shaped article known from the tobacco processing industries.

Preferably, the reference element is a susceptor band arranged in an aerosol-generating article or a marker provided on the outside of a rod-shaped article. A marker may, for example, be printed, embossed, punched or may be a laser perforation.

In particular, in articles comprising a susceptor band to be cut or to be processed otherwise, for example for assembly with other segments, wherein a specific mutual relative position of the susceptor band with another segment is desired or mandatory, the position of the susceptor band should be defined and consistent for all articles. For example, it has been found that a random orientation of the susceptor band in the article may lead to irregular cutting, deformation of the susceptor band or a reduced lifetime of a cutting knife. Thus, it may be beneficial that the mechanical positioning unit interacts with the rod-shaped article to achieve an optimized rotational positioning of the article before further processing the article, for example cutting the article.

In the present invention, the position of the reference element is detected, and if the detected position deviates from a defined position, the article is rotated until the rotational position of the reference element corresponds to the defined position. The controller submits the respective information about the detected position of the reference element to the actuator of the mechanical positioning unit. The actuator activates the mechanical positioning unit to rotate the article until the article has arrived at the defined position.

The conveyor may comprise the holding means. The holding means may be integrated into the conveyor. The article is held by the holding means while being conveyed in the conveyor, for example, to a downstream arranged mechanical positioning unit.

The conveyor may be a conveyor band or a conveyor drum. The conveyor may preferably comprise several seats, each seat for accommodating a rod-shaped aerosol-generating article in the seat.

Conveyors with seats may individually and securely transport an article from a receiving location, where the article is received in the seat of the conveyor and held therein by the holding means, to a further downstream located detection location, where the detection device is arranged for detecting the rotational position of the reference element of the article.

Preferably, the conveyor is a fluted conveyor drum comprising several flutes, each flute for accommodating an aerosol-generating article. Typically, the rod-shaped article is a semi-finished product and a component or a combination of multiple components of a consumable. Through rotation of the conveyor drum the articles may be conveyed to different locations along the periphery of the conveyor drum in a space saving manner.

The apparatus may comprise a marking device for applying a marker on the rod-shaped article when the article is in the defined position.

The apparatus may comprise a cutting device for cutting the rod-shaped article when the article is in the defined position. The marking or cutting device is arranged downstream of the mechanical positioning unit. Thus, it is assured that a rod-shaped article has been positioned to a defined position before being marked by the marking device or before being cut by the cutting device.

The article may be cut by a knife with a straight cutting edge or a knife with a circular cutting edge Preferably, the cutting device, comprises at least one circular cutting knife. In some embodiments, the cutting device comprises several cutting knives, preferably, several circular cutting knives.

Preferably, the cutting device comprises a series of circular cutting knives. The series of circular cutting knives may be arranged in parallel to each other. The series of cutting knives may be arranged in sequence to each other. Series of cutting knives may be arranged in sequence offset to each other as well as in parallel to each other. In typical cutting processes of rod-shaped articles, a rod is cut once, twice or three times simultaneously in parallel. The cut rod is transported further downstream and cut again, preferable several times, by further cutting knives, preferably, until a cut article has a desired length. The desired length may be a final length of an article to be used as a segment in a consumable. The desired length may be a length longer than a final length, as there may be further cutting steps further downstream in the manufacturing line, for example, after an article with a desired length has been attached to other segments.

It has been found that the relative position of a cutting knife with respect to the position of a susceptor band has a large impact on the quality of the cut. It is generally acknowledged that for a clear cut of a rod-shaped article, a plane of a cutting knife and a longitudinal axis of a rod-shaped article should be perpendicular to each other. It has also been found that an optimized cutting angle between the susceptor band and the cutting blade improves not only the quality of the cut but also the lifetime of the cutting knife.

Preferably, in the defined position of the rod-shaped article a cutting angle under which a reference element in the form of a susceptor band in the article is cut by the cutting device is smaller than 90 degrees and preferably between 20 degree and 70 degree. More preferably, the cutting angle is between 30 degree and 60 degree, for example 45 degree plus or minus 5 degrees.

The cutting angle is defined between the plane of the susceptor band and a position of a cutting edge of the cutting device at the moment when the cutting device starts to cut the susceptor band. In the case where the cutting device is a linear knife, the cutting angle is defined between the plane of the susceptor band and the straight cutting edge of the linear knife. In the case where the cutting device is a rotary cutting knife, the cutting angle is defined between the plane of the susceptor band and a tangent of a cutting edge of a rotary cutting knife at the moment when the cutting edge starts to cut the susceptor band.

Thus, preferably, the defined position of a rod-shaped article corresponds to the rotational position of the susceptor band in the article where the above-mentioned cutting angle between susceptor band and cutting device are met. Accordingly, the controller submits the respective information about the detected position of the susceptor band to the actuator of the mechanical positioning unit such that the mechanical positioning unit is activated to rotate the article and until the article has arrived at the defined position corresponding to a rotational position within the defined range of cutting angle.

Preferably, a holding means comprises suction means. Preferably, the suction means are applicable to a seat in the conveyor, wherein the seat is adapted to accommodate the rod-shaped article. Preferably, the holding means is designed to allow temporary rotation of the rod-shaped article. This may be achieved, for example, by reducing a suction force while rotating the article, or by interrupting suction force in a position where the article is rotated. In some embodiments of the present invention, the suction means may be replaced by a retaining surface or guiding element that is provided to prevent an article from falling out from its seat, preferably without interfering with the rotation of the article.

Preferably, the apparatus comprises a guiding element arranged at a distance and parallel to the conveyor for preventing rod-shaped articles to fall off the conveyor. The guiding element may also prevent articles to slip into a next seat or flute in the conveyor. The guiding element is arranged and constructed to allow articles in a conveyor to pass below the guiding element but to keep the articles in the conveyor, for example in a flute of a conveyor drum.

A mechanical positioning unit may be integrated into a guiding element.

A mechanical positioning unit may be realized by various means. A mechanical positioning unit may be integrated into a conveyor or may be external to a conveyor.

For example, the mechanical positioning unit may comprise a moving belt for contacting and rotating a rod-shaped article held in the conveyor. The moving belt may be an actuated endless belt. The moving belt may be arranged at a distance to a conveyor to be able to touch an article in the conveyor.

Rotation of the article may be influenced either by a time period the moving belt is contacting the article, by a speed of the moving belt when contacting the article, by a length of the moving belt contacting the article, or by the pressure of the moving belt applied to the article, or combinations thereof.

Preferably, the actuator of the mechanical positioning unit is adapted to control at least one of speed of the moving belt or distance of the moving belt to the conveyor. While the moving belt is in contact with the article to be rotated, a contact pressure may increase the extent of rotation applied to the article by the moving belt.

The actuator may define a contact duration, a contact length, or a contact pressure of the moving belt with a rod-shaped article to be rotated, wherein preferably the article is accommodated in the seat of a conveyor.

The moving belt may contact one single article only or may contact several articles simultaneously. When contacting and rotating several articles simultaneously, it must be ensured that the defined position for each article is achieved as soon as a contact between an article and he moving belt has ended. A controller may be provided with the individual defined positions of the several articles, as well as with the extent of rotation applied to the several articles rotated simultaneously.

The mechanical positioning unit may comprise a linearly movable curved surface, the surface for contacting and applying pressure to the aerosol-generating article held by the holding means. The curved surface may be brought into contact with the article or articles to be rotated. Preferably, the curved surface is stationary. A linear movement of the curved surface brings the curved surface into contact and out of contact with the article to be rotated. The curved surface causes friction between the article and the curved surface when the article moves past the curved surface upon rotation of the conveyor. A linear movement of the curved surface preferably occurs perpendicular to an article or the linear movement of the curved surface may be radial to the conveyor. By moving the curved surface away and towards an article carried on the conveyor, for example a rotating drum conveyor, the amount of rotation of the article by the curved surface may be varied.

The mechanical positioning unit may comprise at least one activated roller for rolling the aerosol-generating article held in the conveyor.

The at least one activated roller may be arranged in the conveyor. The at least one activated roller may be arranged vis-à-vis a conveyor, for example in a guiding element as mentioned above.

The at least one activated roller may be arranged in an opening in a seat of the conveyor. Thus, an article accommodated in a seat may be rotated by the at least one activated roller in the seat.

The at least one activated roller may be a part of a seat. The at least one activated roller may also be assigned to a seat, when the article is transferred to the positioning location. Thus, the at least one activated roller may be part of a single mechanical positioning unit responsible for the rotation of all articles to be rotated. The at least one activated roller may be integrated in a conveyor. The at least one activated roller may be assigned to a specific article only. One activated roller may also be assigned to several articles simultaneously. Thus, the mechanical positioning unit may comprise several actuators individually actuating the rotation of several articles, either in parallel or subsequently. To ensure the correct defined position of each article, for example before cutting, a controller may be adapted to process all rotations performed simultaneously by the several articles.

In the preferred embodiment of a fluted conveyor drum, each flute of the fluted conveyor drum may comprise an opening for the positioning unit to pass through the opening and rotating the article accommodated in the flute. For example, an activated roller may be arranged inside the conveyor drum and pass into the opening of the flute when a specific flute of the drum has rotated to a position where the article in the flute is to be rotated to the defined position by the activated roller.

The mechanical positioning unit may comprise a multiple rotation element for rotating several aerosol-generating articles simultaneously. The multiple rotation element preferably is a series of individually rotatable levers.

A detection device may be designed in various ways to capture images of the rod-shaped article. Apart from visual systems, such as a camera, for detecting the visible outside of an article, also other detection systems are usable depending on the nature of a reference element in particular compared to the nature of the remaining article. For example, depending on the physical or chemical structure of the reference element different detection devices may be used.

Thus, for example, x-rays may make use of different x-ray absorption properties of different components in the article. For example, a susceptor band is of ferromagnetic material contained in an aerosol-forming substrate. Other examples are inductive sensors for detecting a magnetic field response from an inductive material, such as a magnetic ink or a susceptor band, when being subject to a magnetic field. Or further, infrared (IR)—sensors may be used to detect an elevated temperature in an inductively heatable reference element such as a susceptor band, when the susceptor band has previously been inductively heated.

Preferably, the detection device comprises any one of a camera, an x-ray detection device, an induction detection device, or an infrared sensor. With a camera, preferably, an image of at least a portion of the rod-shaped aerosol-generating article is provided.

The detection device may detect the rotational position of one article or of several articles simultaneously.

The apparatus may comprise an output control arranged at or close to a release location of the conveyor. The output control is for detecting a condition of the reference element in a rod-shaped article at the release location for comparing the detected condition with quality specifications, for rejecting rod-shaped articles as waste when not meeting the quality specifications, and for triggering the actuator of the mechanical positioning unit to adjust the mechanical positioning unit, if the rejected rod-shaped articles exceed a predefined waste threshold.

By the output control, the final result of the entire process in the apparatus may be controlled and used for adjusting the mechanical positioning unit. The output signal provided by the output control may be used to provide fine tuning of the mechanical positioning unit and in particular of a cutting angle or marking position. This may result in even further improved positioned, cut, marked or otherwise processed articles and reduced waste.

The condition of the reference element, for example a susceptor band in the cut article has to meet predefined quality specifications in order to be accepted and not to be rejected as waste.

The output control may detect, for example, a rotational position of the reference element in the rod-shaped article or also the absolute position of the reference element on or in the article. For example, the output control may detect a displacement of a reference element, for example, of a susceptor band out of the center of the article and in the direction of the circumference of a rod-shaped article. The output control may also detect a form of a reference element, for example if the susceptor band has a deformed, for example bent, shape or if a marker has an incorrect shape or is misplaced. These parameters have to be within a certain predefined threshold in order to be accepted. If the predefined thresholds are exceeded, the article is detected as not meeting the predefined quality specifications and the articles are rejected as waste.

Preferably, the output control comprises a rejection system, rejecting defective articles that comprise conditions of the reference element that do not meet the quality specifications.

If a waste ratio (defective articles versus accepted articles) exceeds a predefined waste threshold, detected information on the condition of the reference element by the output control is used to trigger the mechanical positioning unit. The output control may, for example, comprise a camera arranged such as to provide an image of at least a portion of the rod-shaped article. The camera may detect the form and position of the reference element on or in the article. Preferably, the camera is arranged such as to provide an image of at least one end of a cut rod-shaped aerosol-generating article. In general, the camera may detect the position of a reference element of a cut article. The information from the camera may be compared with predefined parameters for the reference element on or in the article.

Preferably, a waste threshold for waste is set for triggering the adjustment of the mechanical positioning unit in order to reduce the waste. Admitted waste for the entire process may, for example, be 1 percent. If the waste increases and exceeds this 1 percent threshold, a mechanical positioning unit adjustment will be triggered in order to reduce the waste.

The apparatus may comprise a velocity sensor for measuring a moving speed of the conveyor. The velocity sensor is coupled to the controller. Thus, any change in the moving speed of a conveyor that may influence a rotational positioning of the articles may be detected and used for adjusting the mechanical positioning means. It is thus possible, to dynamically adjust a rotational position of the articles and consequently also adjust a rotational position of the reference element on the article, for example a position of a susceptor band in the article or the cutting angle of the susceptor band. This is advantageous during ramping up of a process where a conveyor is not yet at its final operational speed and the transport speed of the articles varies while being received by the conveyor and for example cut on the conveyor. For example, during a cut, in general there is a small spinning effect on the rods applied by the circular knifes. As this rod spin is related to the time necessary for cutting the rod, during the ramp up of a machine it is thus preferable having an adjustable cutting angle in order to be able to compensate machine acceleration. In another example, some mechanical positioning units exercise a rotation to the article, which rotation depends on the duration the article is in contact with the mechanical positioning unit and thus rotation depends on the speed of the conveyor passing the mechanical positioning unit.

There is also provided a method for aligning rod-shaped articles comprising a reference element. The method comprises receiving a rod-shaped article comprising a reference element in a seat of a conveyor, and transporting and holding the rod-shaped article comprising the reference element and detecting a rotational position of the rod-shaped article by detecting a position of the reference element of the rod-shaped article while holding the rod-shaped article. The method further comprises using information on a detected position of the reference element of the rod-shaped article and mechanically rotating the rod-shaped article around a longitudinal axis of the article from the detected position to a defined position by a mechanical positioning unit.

Preferably, the method comprises temporarily releasing the rod-shaped article, thereby allowing the rod-shaped article to rotate to the defined position, then fixing the rod-shaped article in the defined position.

Holding and rotating of an article may be performed simultaneously if the forces to rotate the article overcome a holding force. Preferably, a holding of the article is reduced or interrupted for rotating the article. For example, suction applied to an article may be reduced to allow rotation of the article. An applied suction may also be interrupted to release the article from a holding grip. However, in some embodiments of the present invention, the holding means itself may also be changed, for example, switching from a suction force applied to an article to a retaining surface or guiding element that is provided to prevent an article from falling out from its seat, preferably without interfering with the rotation of the article. When the article has been rotated around its longitudinal axis to its defined position, the article is preferably fixed in the defined position for a further processing step, for example by application of suction force to the article.

Preferably, the method comprises keeping the rod-shaped article fixed in the defined position and cutting or marking the article. The fixing allows to perform the cutting or marking at the defined position. Thus, the article is kept in the defined position before and during the cutting or marking. Depending on the further processing of the article, the article is preferably also kept in the defined position after cutting or marking.

The method may comprise detecting the rotational position of the reference element by any one of visual inspection of at least a portion of the rod-shaped article, x-ray inspection of at least parts of the rod-shaped article, inductivity measurements of an inductive reference element such as for example a susceptor band, or infrared measurement of an inductively heated inductive reference element in the article. The different detection methods may be chosen according to a user's needs. For example, if several cutting steps are performed subsequently, preferably a detection device is capable of detecting either the position of the reference element or the form of the reference element, or a combination of position and form of reference element. For example, the detection device may detect the position of a susceptor in the article or the form of a susceptor along its length in the aerosol-generating article or a combination of the position of the susceptor and the form of the susceptor along its length in the aerosol-generating article. By this, a mechanical positioning unit may be activated to achieve best results for an average position of the reference element, for example, along the length of the rod-shaped article.

Detection of the position of a reference element inside an article may also be preferable when several subsequently arranged cutting steps are provided and when several subsequently arranged mechanical positioning units are provided. A detected position for a part of the article to be cut may vary from a detected position of another part of the article, in particular when the article has a long length. Accordingly, a first information may be submitted to an actuator of a most upstream arranged mechanical positioning unit cutting the article at a first position and a second information may be submitted to an actuator of a more downstream arranged mechanical positioning unit cutting the article at a second position. The first information and the second information may be different and the extent of rotation of the article or the cut article may be different.

The method typically comprises transporting the rod-shaped article from a receiving location to a detection location to a positioning location and to a cutting location or a marking location. The detection location is arranged at the receiving location or downstream of the receiving location. Preferably, a detection location is arranged as far upstream of the aligning process of the article as possible in order to have sufficient time to analyse the results of the detection device and in order for the controller to provide the required information to the actuator of the mechanical positioning unit. The positioning location is arranged downstream of the detection location. The distance between the detection location and the positioning location may be adapted to factor in a transport speed of the article and the time required for the detection device to detect the rotational position of the rod-shaped article. A cutting location or a marking location is arranged downstream of the positioning location.

The method may comprise a further detection location and a further cutting arranged downstream of the cutting or marking location. The article may be cut into several segments in several cutting steps as already described above.

The method may further comprise an output control detecting a condition of the reference element of a final rod-shaped article and rejecting final rod-shaped articles with defective reference elements as waste. If the waste exceeds a predefined waste threshold, the method comprises using information on a detected output condition of the reference element in the rod-shaped article to trigger the mechanical positioning unit and thereby to adjust the rotating of the rod-shaped article.

Thus, while any defective articles, thus any articles where the detected condition of the reference element does not meet predefined quality specifications, are preferably rejected as waste, adjustment of the mechanical positioning unit is preferably initialized only when a waste ratio exceeds a predefined waste threshold.

The final article is the article after a final cutting step, after a marking step or the article ready to be released from the conveyor. Preferably, the output control detects a condition of a susceptor band in a final cut aerosol-generating article, and rejects final cut aerosol-generating articles with defective susceptor bands as waste.

Preferably, the method comprises measuring a transport speed of the rod-shaped article and depending on the transport speed adjusting at least one of detection of the rotational position of the susceptor band in the aerosol-generating article or rotation of the rod-shaped article to its defined position.

Preferably, the method comprises cutting the aerosol-generating article in its defined position, thereby cutting the reference element in the form of a susceptor band at a cutting angle smaller than 90 degrees and preferably between 20 degrees and 70 degrees. More preferably, the cutting angle is between 30 degrees and 60 degrees, for example 45 degrees plus or minus 5 degrees.

Preferably, the method comprises holding the rod-shaped article by suction force applied to the article.

Preferably, the method comprises rotating the rod-shaped article by contacting the rod-shaped article by a moving belt, an activated roller or a multiple rotation element.

Preferably, the method comprises transporting the rod-shaped article in a flute of a fluted conveyor drum. When using a fluted conveyor drum, the method preferably comprises continuously providing rod-shaped articles to flutes of the fluted conveyor drum. Preferably, the method further comprises individually detecting and rotating each of the rod-shaped articles to the defined position according to detected rotational positions of the reference elements of the articles.

The rod-shaped articles may subsequently be detected by a detection device and subsequently be rotated by the mechanical positioning unit. Therein, the articles may subsequently be detected by a single detection device and rotated by a single mechanical positioning unit. Several rod-shaped articles may also be rotated simultaneously, preferably, be their own mechanical positioning unit assigned to each of the several articles.

As used herein, the term ‘susceptor’ refers to a material that is capable to convert electromagnetic energy into heat. When located in an alternating electromagnetic field, typically eddy currents are induced and hysteresis losses may occur in the susceptor causing heating of the susceptor. As the susceptor is located in thermal contact with aerosol-forming substrate, the aerosol-forming substrate is heated by the susceptor, releasing aerosol-forming substances from the substrate.

The susceptor may be formed from any material that can be inductively heated to a temperature sufficient to release material from the aerosol-forming substrate. Preferred susceptors comprise a metal or carbon. A preferred susceptor may comprise or consist of a ferrous or ferromagnetic material, for example ferritic iron, a ferromagnetic alloy, such as ferromagnetic steel, stainless steel or aluminium. The susceptor preferably comprises more than 5 percent, preferably more than 20 percent, preferably more than 50 percent or 90 percent of ferromagnetic or paramagnetic materials. Preferred susceptors may be heated to a temperature between about 150 degree Celsius and about 300 degree Celsius. Preferably, the susceptors may be heated to a temperature between about 200 degree Celsius and about 270 degree Celsius, for example 235 degree Celsius.

Preferably, a susceptor sheet material as is a metallic band.

Preferably, a susceptor sheet material is a stainless steel band. However, susceptor materials may also comprise or be made of graphite, molybdenum, silicon carbide, aluminum, niobium, Inconel alloys (austenite nickel-chromium-based superalloys), metallized films, ceramics such as for example zirconia, transition metals such as for example Iron, Cobalt, Nickel, or metalloids components such as for example Bor, Carbon, Silicium, Phosphor, Aluminium.

Preferably, the susceptor band has a basic rectangular shape having a width preferably between about 2 millimeter and about 8 millimeter, more preferably, between about 3 millimeter and about 5 millimeter, for example 4 millimeter and a thickness preferably between about 0.03 millimeter and about 1 millimeter, more preferably between about 0.05 millimeter and about 0.5 millimeter, for example between about 0.07 millimeter and about 0.2 millimeter. The width of the susceptor band is smaller than a width or diameter of a rod-shaped aerosol-generating article the susceptor band is arranged in.

As a general rule, whenever the term ‘about’ is used in connection with a particular value throughout this application this is to be understood such that the value following the term ‘about’ does not have to be exactly the particular value due to technical considerations. However, the term ‘about’ used in connection with a particular value is always to be understood to include and also to explicitly disclose the particular value following the term ‘about’. The rod-shaped article has the form of a rod with a rod diameter, preferably in the range between about 3 millimeters to about 12 millimeters, more preferably between about 4 millimeters to about 8 millimeters, for example 7 millimeters. Preferably, the rod has a circular or oval cross-section. However, the rod may also have the cross-section of a rectangle or of a polygon.

The rod-shaped article in the form of an aerosol-generating article comprises an aerosol-forming substrate, capable of forming an aerosol. The aerosol-forming substrate is a solid and may comprise a tobacco-containing material containing volatile tobacco flavour compounds, which are released from the substrate upon heating. Alternatively, the aerosol-forming substrate may comprise a non-tobacco material. The aerosol-forming substrate may further comprise an aerosol former. Examples of suitable aerosol formers are glycerine and propylene glycol.

The aerosol-forming substrate may comprise one or more sheets of homogenised tobacco material that has been gathered into a rod, provided with the susceptor band and circumscribed by a wrapper. Preferably, the aerosol-forming substrate comprises a crimped and gathered sheet of homogenised tobacco material.

A tobacco sheet forming the aerosol-forming substrate may comprise tobacco particles, fiber particles, aerosol former, binder and for example also flavours.

Preferably, the aerosol-forming tobacco substrate is a tobacco sheet, preferably crimped, comprising tobacco material, fibers, binder and aerosol former. Preferably, the tobacco sheet is a cast leaf. Cast leaf is a form of reconstituted tobacco that is formed from a slurry including tobacco particles, fiber particles, aerosol former, for example glycerol or propylene glycol, binder and for example also flavours.

The invention is defined in the claims. However, below there is provided a non-exhaustive list of non-limiting examples. Any one or more of the features of these examples may be combined with any one or more features of another example, embodiment, or aspect described herein.

Example Ex1: Apparatus for aligning rod-shaped articles comprising a reference element, the apparatus comprising a conveyor for accommodating and transporting a rod-shaped article comprising a reference element; a holding means for holding the rod-shaped article in the conveyor, the holding means allowing temporary rotation of the rod-shaped article; a detection device for detecting the rotational position of the rod-shaped article by detecting the position of the reference element; a mechanical positioning unit to rotate the rod-shaped article held by the holding means around a longitudinal axis of the article; a controller for submitting information on the rotational position of the reference element of the rod-shaped article provided by the detection device to an actuator of the mechanical positioning unit, wherein the actuator is adapted to activate the mechanical positioning unit such that the rod-shaped article is rotated around the longitudinal axis from a detected position to a defined position by the mechanical positioning unit.

Example Ex2: Apparatus according to Example Ex1, wherein the reference element is a susceptor band arranged in the rod-shaped article or a marker provided on the outside of the rod-shaped article.

Example Ex3: Apparatus according to any one of the preceding Examples, wherein the conveyor is a fluted conveyor drum comprising several flutes, each flute for accommodating a rod-shaped article.

Example Ex4: Apparatus according to any one of the preceding Examples, comprising a marking device for applying a marker on the rod-shaped article in the defined position.

Example Ex5: Apparatus according to any one of the preceding Examples, comprising a cutting device for cutting the rod-shaped article in the defined position.

Example Ex6: Apparatus according to Example Ex5, wherein the cutting device comprises at least one circular cutting knife.

Example Ex7: Apparatus according to Example Ex6, wherein the cutting device comprises a series of circular cutting knives arranged in parallel to each other or arranged in sequence to each other or arranged in parallel as well as in sequence to each other.

Example Ex8: Apparatus according to any one of Examples Ex 5 to Ex7, wherein the reference element is a susceptor band and the cutting device is positioned in the apparatus such that in the defined position of the rod-shaped article a cutting angle under which the susceptor band in the article is cut by the cutting device is between 20 degree and 70 degree.

Example Ex9: Apparatus according to any one of the preceding Examples, wherein the holding means comprises suction means applicable to a seat in the conveyor.

Example Ex10: Apparatus according to any one of the preceding Examples, comprising a guiding element arranged at a distance and parallel to the conveyor.

Example Ex11: Apparatus according to any one of the preceding Examples, wherein the mechanical positioning unit comprises a moving belt for contacting and rotating a rod-shaped article held in the conveyor.

Example Ex12: Apparatus according to Example Ex11, wherein the actuator is adapted to control at least one of speed of the moving belt or distance of the moving belt to the conveyor.

Example Ex13: Apparatus according to any one of the preceding Examples, wherein the mechanical positioning unit comprises a linearly movable curved surface for contacting and applying pressure to the rod-shaped article held in the conveyor.

Example Ex14: Apparatus according to any one of the preceding Examples, wherein the mechanical positioning unit comprises at least one activated roller for rolling the rod-shaped article held in the conveyor.

Example Ex15: Apparatus according to Example Ex14, wherein the at least one activated roller is arranged in the conveyor.

Example Ex16: Apparatus according to Example Ex15, wherein the at least one activated roller is arranged in an opening in a seat in the conveyor.

Example Ex17: Apparatus according to any one of Examples Ex1 to Ex11, wherein the mechanical positioning unit comprises a multiple rotation element for rotating several rod-shaped articles.

Example Ex18: Apparatus according to Example Ex17, wherein the multiple rotation element is a series of individually rotatable levers.

Example Ex19: Apparatus according to Example Ex3, wherein each flute of the fluted conveyor drum comprises an opening for the positioning unit to pass through the opening and rotating the article accommodated in the flute.

Example Ex20: Apparatus according to any one of the preceding Examples, wherein the detection device comprises any one of a camera, an x-ray detection device, an induction detection device, or an infrared sensor.

Example Ex21: Apparatus according to any one of the preceding Examples, comprising an output control arranged at a release location of the conveyor, the output control for detecting a condition of the reference element in a rod-shaped article at the release location for comparing the detected condition with quality specifications, and for triggering the actuator of the mechanical positioning unit to adjust the mechanical positioning unit.

Example Ex22: Apparatus according to Example Ex21, wherein the output control comprises a camera arranged such as to provide an image of at least a portion of the rod-shaped article.

Example Ex23: Apparatus according to any one of the preceding Examples, comprising a speed sensor for measuring a moving speed of the conveyor, wherein the velocity sensor is coupled to the controller.

Example Ex24: Method for aligning rod-shaped articles comprising a reference element, the method comprising: receiving a rod-shaped article comprising a reference element in a seat of a conveyor; transporting and holding the rod-shaped article comprising the reference element; detecting a rotational position of the rod-shaped article by detecting a position of the reference element of the rod-shaped article, while holding the rod-shaped article; using information on a detected position of the reference element of the rod-shaped article and mechanically rotating the rod-shaped article around a longitudinal axis of the article from the detected position to a defined position by a mechanical positioning unit.

Example Ex25: Method according to Example Ex24, therein temporarily releasing the rod-shaped article, allowing the rod-shaped article to rotate to the defined position, then fixing the rod-shaped article in the defined position.

Example Ex26: Method according to Example Ex22, wherein the rod-shaped article is kept fixed in the defined position while being cut or marked.

Example Ex27: Method according to any one of Examples Ex22 to Ex26, therein detecting the rotational position of the reference element by any one of visual inspection of at least a portion of the rod-shaped article, x-ray inspection of at least parts of the rod-shaped article, inductivity measurements of an inductive reference element or infrared measurement of an inductively heated inductive reference element in the article.

Example Ex28: Method according to any one of Examples Ex22 to Ex27, therein transporting the rod-shaped article from a receiving location to a detection location to a positioning location and to a cutting location or a marking location, wherein the detection location is arranged at the receiving location or downstream of the receiving location, the positioning location is arranged downstream of the detection location and the cutting location or marking location is arranged downstream of the positioning location.

Example Ex29: Method according to Example Ex28, comprising a further detection location and a further cutting location arranged downstream of the cutting location or marking location.

Example Ex30: Method according to any one of Examples Ex22 to Ex28, further comprising an output control detecting a condition of the reference element of a final rod-shaped article, rejecting final rod-shaped articles with defective reference elements as waste; and if the waste exceeds a predefined waste threshold, using information on a detected output condition of the reference element in the final rod-shaped article to trigger the mechanical positioning unit and thereby adjust the rotating of the rod-shaped article.

Example Ex31: Method according to any one of Examples Ex22 to Ex30, therein measuring a transport speed of the rod-shaped article and depending on the transport speed adjusting at least one of detection of the rotational position of the reference element of the rod-shaped article or rotation of the article to its defined position.

Example Ex32: Method according to any one of Examples Ex26 to Ex31, therein cutting the rod-shaped article in its defined position thereby cutting the reference element in the form of a susceptor band at a cutting angle between 20 degrees and 70 degrees.

Example Ex33: Method according to any one of Examples Ex22 to Ex32, therein holding the rod-shaped article by suction force applied to the article.

Example Ex34: Method according to any one of Examples Ex22 to Ex33, therein rotating the rod-shaped article by contacting the rod-shaped article by a moving belt, an activated roller or a multiple rotation element.

Example Ex35: Method according to any one of Examples Ex22 to Ex34, therein transporting the rod-shaped article in a flute of a fluted conveyor drum.

Example Ex36: Method according to Example Ex35, continuously providing rod-shaped articles to flutes of the fluted conveyor drum and individually detecting and rotating each of the rod-shaped articles to the defined position according to detected rotational positions of the reference elements of the articles.

Example Ex37: Method according to Example Ex36, wherein the rod-shaped articles are subsequently detected by a detection device and are subsequently rotated by the mechanical positioning unit.

Example Ex38: Method according to Example Ex36, wherein several rod-shaped articles are rotated simultaneously.

Examples will now be further described with reference to the figures in which:

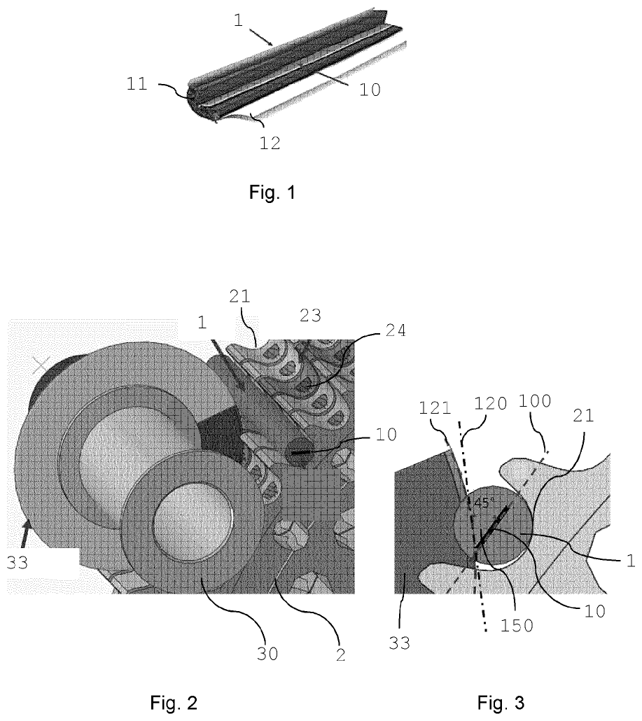

FIG. 1 shows a perspective cut-open view of a rod-shaped aerosol-generating article comprising a susceptor band;

FIG. 2 shows a detailed view of an aerosol-generating article in the cutting position;

FIG. 3 shows an aerosol-generating article being cut;

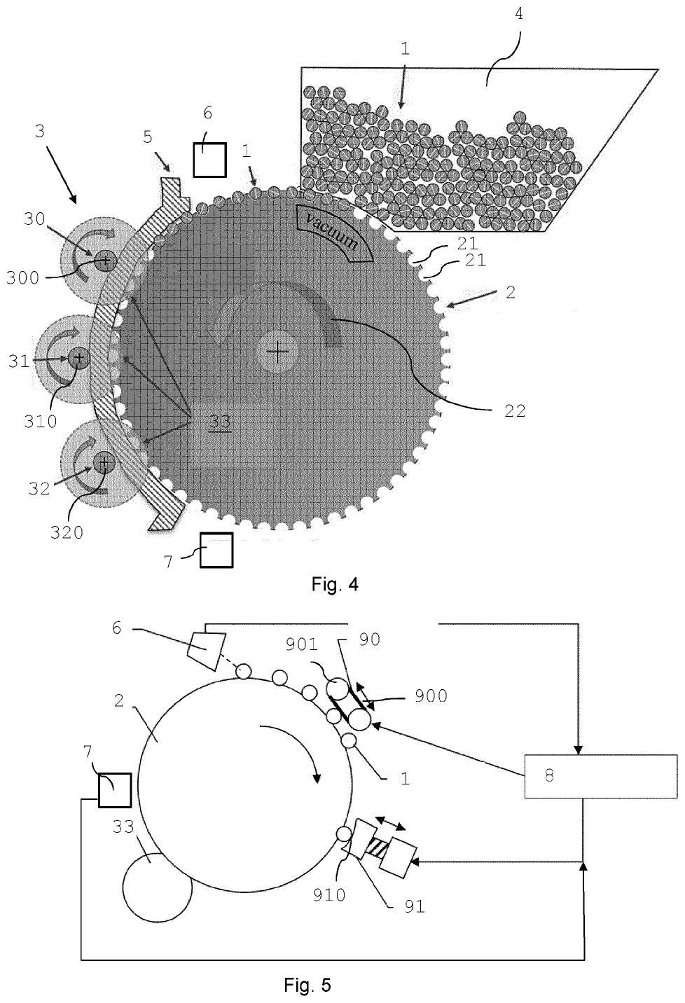

FIG. 4 schematically shows a cutting process of rod-shaped articles on a fluted conveyor drum;

FIG. 5 shows an apparatus with two embodiments of a mechanical positioning unit;

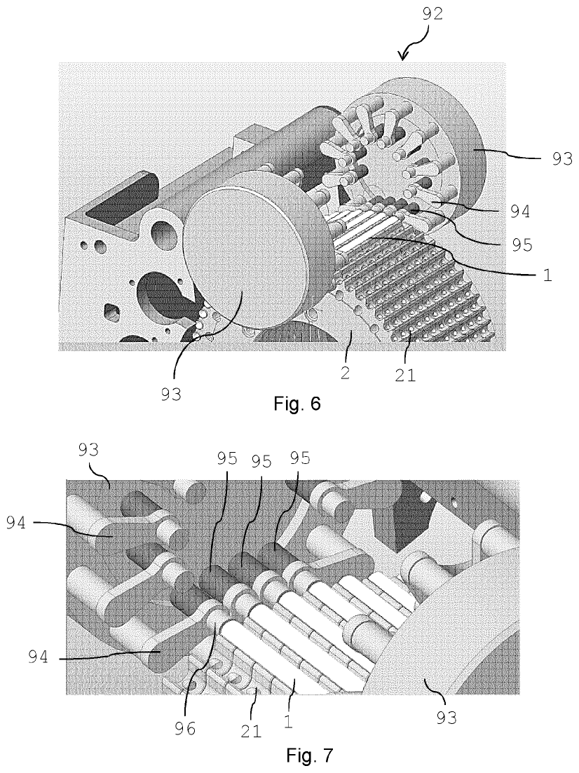

FIG. 6 shows another embodiment of a mechanical positioning unit; and

FIG. 7 shows a detail of the apparatus of FIG. 6.

FIG. 1 shows a cut-open view of a rod-shaped aerosol-generating article 1 comprising a reference element in the form of a susceptor band 10. A continuous planar susceptor band 10 is arranged along the center of a continuous aerosol-forming substrate 11. The substrate 11 may be a gathered sheet of homogenized tobacco material. The article 1 is wrapped with a wrapping material 12, for example a paper wrapper. The article 1 is cut from a continuous rod and typically has a length which is a multiple of the length of a final plug that is subsequently combined with other segments to create the final consumable. The final consumable may be used in electronic inductive heating devices for aerosol generation by inductively heating the susceptor band 10 and the aerosol-forming substrate 11 in the vicinity of the susceptor band 10.

Usually, initial rods have a length of 120 mm and are cut into 10 plugs by several cutting steps, each plug then having a length of 12 mm.

In FIG. 2 a detailed view of the article 1 just before being cut is shown. The article 1 is arranged in a flute 21 of a conveyor drum 2. The conveyor drum is assembled from several individual parallel arranged disks 23 forming the flutes 21 at their circumference. The disks 23 are provided with slits in between the disks 23 for a cutting knife 33 to enter in between the disks 23 when cutting the article 1. The flutes 21 are provided with throughholes 24 communicating with the interior of the conveyor drum 2 and a suction device arranged inside the conveyor drum (not shown here). The article 1 is rotated to a defined optimal position, which is in this embodiment defined by the relative position between susceptor band 10 and cutting knife 33.

An important point for the efficiency of the use of a consumable comprising a plug made of an aerosol-forming substrate comprising a susceptor band is that the rectangular susceptor band inside the plug is in the center of the plug arranged along the central longitudinal axis of the plug. The susceptor band 10 should not be moved, deformed, damaged or bent during the cut. Such unwanted modifications of the shape of the susceptor band and the position of the susceptor band inside a plug alters the heating of the final consumable and may create inefficiency and waste of aerosol-forming substrate as well as inconsistency of the consumables.

It appears that the orientation of the susceptor band inside the aerosol-forming substrate rods before the cut performed by the circular knife 33 has a huge impact on the quality of the cut.

It has been found that the best orientation of the susceptor band in order to have an efficient cut is approximately a cutting angle 150 of 45 degree+5 degree. Such an optimal position is shown in more detail in FIG. 3.

The orientation of the article 1 or the susceptor band 10 in the article, respectively, is calculated before the circular knife 33 starts to cut the susceptor band 10. The cutting angle 150 of 45 degree is calculated considering the angle between a straight line 100 passing through the plane of the susceptor band 10 and the tangent 120 of the circumference 121 or external diameter of the circular knife 33.

As shown in an overview in FIG. 4, aerosol-generating articles 1 comprising a susceptor band 10 but possibly rod-shaped articles comprising any other reference element, are provided in a hopper 4, which is arranged above the conveyor drum 2. The articles are then fed into flutes 21 of the fluted conveyor drum 2 in a receiving location using gravity and suction force.

The articles 1 are held in the flutes 21 by suction force applied to the flutes from the interior of the conveyor drum 2.

The articles 1 are transported by rotation of the conveyor drum 2 (indicated by arrow 22) to subsequent first, second and third cutting locations, where the articles are cut transversally by rotating circular knives 33.

The cutting is performed in the embodiment of FIG. 4 in three cutting steps using three different cutting knife arrangements. In a first cutting arrangement 30, for example two cuts are applied to the article, in a second cutting arrangement 31 for example three cuts are applied and in a third and last cutting arrangement 32 for example four cuts are applied to the article 1.

Before being cut, the articles 1 pass a detection device 6. The detection device 6 detects the position of the reference element and by the rotational asymmetry of the reference element the rotational position of the article in the flute 21. Here the detection device detects the rotational position of the susceptor band 10 in the article 1. The detection device may be a camera taking an image of the article or several articles passing the detection device 6.

The cutting device 3 comprises three cutting arrangements 30,31,32. Each cutting arrangement comprises at least one, but preferably two or more circular knives 33, which are arranged in parallel on a common rotatable cutting shaft 300,310,320. The three cutting arrangements 30,31,32 are arranged subsequently and preferably equidistantly along the circumference and moving direction of the conveyor drum 2.

The cutting device 3 is integrated into a guiding element 5. The guiding element 5 is a curved plate arranged parallel to the circumference of the conveyor drum 2. The guiding element 5 prevents the articles 1—cut or uncut—to fall out of the flutes 21. The guiding element 5 comprises slits for the cutting knives 33 to pass through the slits for cutting the articles 1 in the flutes 21.

Suction force may be provided under the hopper 4 only. Suction force may also be provided from the hopper 4 to the guiding element 5.

As may be seen in FIG. 4, the articles 1 are fed with random rotational orientation to the drum 2. Thus, the orientation of the susceptor bands or other reference elements in the articles 1 also is random. This random susceptor orientation generates high rejects on the machine, for example more than 15 percent, due to an improper cut of the susceptor band (displaced, bent or deformed susceptor band). In addition, good orientation of the susceptor band and cut angle helps to increase the lifetime of the circular knives.

To change the orientation of the susceptor band to an optimized cutting position, i.e. a defined position, the articles are rotated by at least one mechanical position unit arranged upstream of the cutting device 3 (not shown in FIG. 4). Information on the actual rotational position of the susceptor band 10 is thereby provided by the detection device 6, which is in communication with the mechanical positioning unit.

The apparatus is further provided with an output control 7 arranged downstream of the last cutting arrangement 32. The output control detects an inefficient cut of the susceptor band. The output control 7 comprises, for example, a camera or other, preferably optical, device to detect the condition of the reference element, for example the rotational position of the final cut article. The output control 7 may, for example, provide an image of at least an end portion of the cut rod-shaped aerosol-generating article 1, of both ends of the article or of the susceptor band within the cut article.

The output control 7 is in communication with a mechanical positioning unit that is shown in more detail in FIG. 5. The information on the condition of the reference element, for example the form or position of the susceptor band in the final cut articles is used to decide on defective or acceptable articles. If a waste threshold id exceeded this information is then used to act on an actuator of a mechanical positioning unit to adjust the rotating of the aerosol-generating article to the defined position.

By the output control 7, the final result of the entire cutting process may be controlled and used for adjusting the mechanical positioning unit. This may result in even further improved cut articles and reduced waste. The output control 7 may uniquely or additionally be used as final control unit giving information to a discharge unit (not shown) to discharge damaged or defective cut articles 1.

In FIG. 5, a simplified apparatus set-up comprising two different mechanical positioning units 90,91 is shown.

Articles 1 comprising a reference element are provided on a conveyor drum 2. The articles are transported on the conveyor drum from a receiving location to a detection location, where the position of the reference elements is detected by the detection device 6. The articles 1 are further transported to a mechanical positioning unit 90 comprising a moving belt 900. The moving belt is an endless belt arranged to contact the articles 1 when passing underneath the moving belt. The moving belt 900 is moved by activated rollers 901. Preferably, the moving belt is movable in a forward and backward direction which is indicated by arrows. The moving belt 900 may also be movable in a single direction only. The articles 1 are made to rotate by frictional forces and by a difference of moving speed of the conveyor 2 and moving belt 900.

In some embodiments, it is possible, to change a time duration the moving belt contacts the article or a force acting on the article by the moving belt 900 by radially moving the positioning unit 90.

The information from the detection device 6 on the position of the reference element and the rotational position of the article 1 on the conveyor drum 2 are provided to a controller 8. In the controller 8, the information from the detection device 6 is used to calculate the operation of the mechanical positioning unit 90 or its activator. The controller 8 gives according information to the activated rollers 901 to move the moving belt 900 such that the article passing the mechanical positioning unit 90 is rotated to its defined position.

For illustration purpose, a second embodiment of a mechanical positioning unit 91 comprising a linearly movable curved surface 910, is shown in the same apparatus. The curved surface 910 is adapted to contact an article when the article passes the surface 910. Frictional force between the curved surface and the article make the article to rotate when the article moves on the conveyor drum 2, while the curved surface 910 is stationary. The curved surface 910 is linearly movable in a radial direction away and towards the conveyor 2. By a contact duration and applied pressure by the curved surface 910 an extent of rotation of the article 1 may be defined. According operation information is received from the controller 8.

The articles now in the defined position optimized for cutting the articles 1 are further transported to the cutting location, where they are cut by cutting knife 33.

The apparatus may be provided with an output control 7, for example a camera detecting the result of the positioning and cutting process. The output control 7 is in communication with the controller 8. Any information of the output control of defective articles, e,g, unclear or unprecise cuts, is provided to the controller to be used for sorting out waste and possibly for adjustment of the positioning units 90,91.

For simplicity reasons, any guiding element holding the articles on the conveyor 2 are omitted in FIG. 5. Mechanical positioning units 90,91 as well as the cutting knife 33 may be arranged on or integrated into such a guiding element. The guiding element is provided with according openings for the mechanical positioning units 90,91 to pass through the guiding element.

In FIG. 6 and FIG. 7 a mechanical positioning unit 92 simultaneously rotating several rod-shaped articles 1 in flutes 21 of a conveyor drum 2 is shown. The mechanical positioning unit 92 comprises two disk-shaped cam chambers 93 arranged at opposite sides of the conveyor 2 facing each other. Several levers 94, here twelve levers, are arranged equidistantly on an inner circumference of the cam chambers 93. Each lever 94 is provided with a contact protrusion 96 directing inwardly, in axial direction of the longitudinal axis of the article for contacting opposite ends of an article.

Each lever 94 is provided with a drive element 95, for example a small motor, for rotating the article when the article is in contact with the contact protrusion 96. Preferably, the drive elements 95 allow for a maximum rotation of 90 degrees. The drive elements 95 are operated by a controller 8 following the information from a detection device 6.

Each lever 94 is driven by a cam profile arranged in the cam chambers 93. The cam profile allows the levers 94 to rotate such that the contact protrusions 96 may follow the articles 1 on the drum (concave curve). In addition, each lever 94 can move axially according to a cam profile in order to apply a minimum pressure to the ends of the article to allow rotation of the articles by the drive elements 95.

While four articles are rotated simultaneously in the embodiment of FIGS. 6 and 7, each article may be rotated individually by its own drive element 95.

The examples shown in the drawings are mainly embodiments where the reference elements are susceptor bands. However, the reference elements may also be realized differently, for example, as a marker such as a printed form, local laser perforation or similar on a side only of the article. In addition, the positioning of the article has been described in view of an optimal cutting position. However, the positioning may also be performed, for example, for a marking of the article. In addition, the positioning may also be performed as a single action on the conveyor drum, while a further handling process with the article is performed further downstream in a manufacturing line requiring an exact position of the article.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A+2% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1-15. (canceled)

16. An apparatus for aligning rod-shaped articles comprising a reference element, the apparatus comprising:
a conveyor configured to accommodate and to transport a rod-shaped article comprising a reference element;
a holding means for holding the rod-shaped article in the conveyor, the holding means allowing temporary rotation of the rod-shaped article;
a detection device configured to detect a rotational position of the rod-shaped article by detecting a position of the reference element;
a mechanical positioning unit to rotate the rod-shaped article held by the holding means around a longitudinal axis of the rod-shaped article; and
a controller configured to submit information on the rotational position of the reference element of the rod-shaped article provided by the detection device to an actuator of the mechanical positioning unit,
wherein the actuator is configured to activate the mechanical positioning unit such that the rod-shaped article is rotated around the longitudinal axis of the rod-shaped article from a detected position to a defined position by the mechanical positioning unit.

17. The apparatus according to claim 16, wherein the reference element is a susceptor band arranged in the rod-shaped article or a marker provided on an outside of the rod-shaped article.

18. The apparatus according to claim 16, wherein the conveyor is a fluted conveyor drum comprising several flutes, each flute being configured to accommodate a rod-shaped article.

19. The apparatus according to claim 16, further comprising a cutting device configured to cut the rod-shaped article in the defined position.

20. The apparatus according to claim 16, further comprising a guiding element arranged at a distance and parallel to the conveyor.

21. The apparatus according to claim 16, wherein the mechanical positioning unit comprises a moving belt configured to contact and to rotate a rod-shaped article held in the conveyor.

22. The apparatus according to claim 21, wherein the actuator is further configured to control at least one of speed of the moving belt or distance of the moving belt to the conveyor.

23. The apparatus according to claim 16, wherein the mechanical positioning unit comprises at least one activated roller configured to roll the rod-shaped article held in the conveyor.

24. The apparatus according to claim 23, wherein the at least one activated roller is arranged in the conveyor.

25. The apparatus according to claim 24, wherein the at least one activated roller is arranged in an opening in a seat of the conveyor.

26. The apparatus according to claim 16, wherein the mechanical positioning unit comprises a multiple rotation element configured to rotate several rod-shaped articles.

27. The apparatus according to claim 18, wherein said each flute of the fluted conveyor drum comprises an opening configured for the mechanical positioning unit to pass through the opening and for rotating the rod-shaped article accommodated in said each flute.

28. The apparatus according to claim 16, further comprising an output control arranged at a release location of the conveyor, the output control being configured to detect a condition of the reference element in a rod-shaped article at the release location to compare the detected condition with quality specifications, and to trigger the actuator of the mechanical positioning unit to adjust the mechanical positioning unit.

29. A method for aligning rod-shaped articles comprising a reference element, the method comprising:
receiving a rod-shaped article comprising a reference element in a seat of a conveyor;
transporting and holding the rod-shaped article comprising the reference element;
detecting a rotational position of the rod-shaped article by detecting a position of the reference element of the rod-shaped article, while holding the rod-shaped article; and
using information on a detected position of the reference element of the rod-shaped article and mechanically rotating the rod-shaped article around a longitudinal axis of the rod-shaped article from the detected position to a defined position by a mechanical positioning unit.

30. The method according to claim 29, further comprising cutting the rod-shaped article in the defined position thereby cutting the reference element in a form of a susceptor band at a cutting angle between 20 degrees and 70 degrees.
